(19) United States
(12) Patent Application Publication
(10) Pub. No.: US 2017/0286838 A1
(43) Pub. Date: Oct. 5, 2017

(54) PREDICTING SOLAR POWER GENERATION USING SEMI-SUPERVISED LEARNING

(71) Applicant: INTERNATIONAL BUSINESS MACHINES CORPORATION, Armonk, NY (US)

(72) Inventors: James P. Cipriani, Danbury, CT (US); Ildar Khabibrakhmanov, Syosset, NY (US); Younghun Kim, White Plains, NY (US); Siyuan Lu, Yorktown Heights, NY (US); Anthony P. Praino, Poughquag, NY (US)

(21) Appl. No.: 15/083,661

(22) Filed: Mar. 29, 2016

(51) Int. Cl. G06N 5/04; G06N 99/00

(52) U.S. Cl. CPC G06N 5/04; G06N 99/005

(57) ABSTRACT

A method for predicting solar power generation receives historical power profile data and historical weather micro-forecast data at a given location for a set of days. Based on power output features for the days, clusters are generated. A classification model that assigns a day to a generated cluster according to weather features is created. For each cluster, a regression model that takes as input weather features and outputs predicted solar power is built. A system includes a sensor for collecting meteorological data at a solar farm, a meter for measuring photovoltaic power output of the solar farm, and a computer processor for executing instructions to predict solar power generation at the solar farm according to the method disclosed, based on data from the sensor and the meter, for a predefined time period. Further instructions predict solar power generation at the solar farm based on a micro-forecast for the solar farm.

### BACKGROUND

The present invention relates generally to the field of photovoltaic power generation, and more particularly to predicting solar power generation on a computer using semi-supervised machine learning.

Solar power is the conversion of sunlight into electricity. Photovoltaic (PV) systems convert solar irradiance into useful electrical energy using the photovoltaic effect. Although in 2009 there was not a single PV solar facility larger than 100 megawatts (MW) operating in the U.S., today PV solar has the capacity to produce more than 8,100 MW of electricity in the U.S., and the International Energy Agency has projected that by 2050, solar photovoltaics could contribute about 16% of the worldwide electricity consumption, making solar the world's largest source of electricity. However, substantial grid integration of solar power is a challenge, since solar power generation is intermittent and uncontrollable. While variability in solar output due to changes in the sun's position throughout the day and throughout the seasons is predictable, changes in ground-level irradiance due to clouds and local weather conditions creates uncertainty that makes modeling and predicting solar power generation difficult.

In a smart grid, grid operators strive to ensure that power plants produce the right amount of electricity at the right time, in order to consistently and reliably meet demand. Because the grid has limited storage capacity, the balance between electricity supply and demand must be maintained at all times to avoid blackouts or other cascading problems. Grid operators typically send a signal to power plants every few seconds to control the balance between the total amount of power injected into the grid and the total power withdrawn. Sudden power generation shortfalls or excesses due to intermittency may require a grid operator to maintain more reserve power in order to quickly act to keep the grid balanced.

One approach to dealing with solar power intermittency is the use of storage technology, such as large-scale batteries. However, batteries are expensive and susceptible to wear when subjected to excessive cycling. More accurate and flexible power output models may be advantageous in reducing such cycling.

Another source of intermittent renewable energy is wind power. In some cases, a solar power plant may also include wind turbines. This may be advantageous since peak wind and solar power are usually generated at different times of the day and during complementary seasons and, moreover, wind power may be generated when weather conditions are unfavorable for solar power generation. Thus, having both sources may help ensure that the level of energy being fed into the grid is steadier than that of a wind or PV power plant alone.

A method of accurately predicting the output of solar power plants for various forecast time periods and conditions would be a valuable grid management tool, allowing grid operators and utilities to reduce the costs of integrating sources of solar power generation into the existing grid.

The term solar farm as used here refers to an installation or area of land on which a large number of PV solar panels are installed in order to generate electricity. Another term commonly used is utility-scale PV solar application. The standard definition of a solar farm is not based on the number of panels present or on the amount of energy generated, but on the purpose of the energy. If the primary purpose of power from a solar application is sale for commercial gain, then it is considered a utility-scale solar application. Energy generated by a solar farm is typically sold to energy companies, rather than to end users. A solar farm both generates and consumes power. Measuring of net power is typically done using a bidirectional electricity meter, a process often referred to as net metering. A device that performs net metering is a net meter.

### SUMMARY

Embodiments of the present invention disclose a computer-implemented method, computer program product, and system for predicting photovoltaic solar power generation.

In one aspect of the invention, a method comprises receiving historical power profile data and historical weather micro-forecast data at a given location for a set of days. Based on power output features of days of the set of days, clusters are generated. A classification model that assigns a day to a generated cluster according to weather features of the day is created. For each generated cluster, a regression model that takes as input weather features of a day and outputs predicted solar power is built. One advantage of the disclosed method, based on clustering, classification, and regression, may be reduced bias relative to present solar power output prediction models.

In an aspect of the invention, the historical weather micro-forecast data comprises measurements at specified time intervals of one or more of: direct normal irradiance, direct horizontal irradiance, diffuse horizontal irradiance, global horizontal irradiance, and solar zenith angle. Such historical weather micro-forecast data is advantageous in being particularly relevant to solar power generation.

In another aspect of the invention, the method further comprises receiving a weather micro-forecast for the given location for a range of days. The weather features for a day of the range of days are determined from the weather micro-forecast. The classification model is used to assign the day to a generated cluster, based on the determined weather features. The regression model for the generated cluster is used to compute a predicted power output for the day. One advantage of this method may be to provide a solar power output prediction with reduced bias relative to current methods.

In another aspect of the invention, a system comprises a sensor for collecting meteorological data in a region of a solar farm for use in a numerical weather model, a meter for measuring photovoltaic power output of the solar farm, one or more computer processors, one or more non-transitory computer-readable storage media, and program instructions stored on the computer-readable storage media for execution by at least one of the processors. The program instructions include program instructions to: receive meteorological data collected from the sensor; receive photovoltaic power output measurements measured by the meter, corresponding to a predefined time period; generate a weather micro-forecast for the time period in the region of the solar farm, based on the meteorological data and the numerical weather model; produce a profile of photovoltaic power generated during the time period at the solar farm, based on the photovoltaic power output measurements; receive the photovoltaic power profile and the weather micro-forecast at the solar farm for a set of days of the time period; generate clusters from the set of days corresponding to types of days, according to power output features of days of the set of days; create a classification model that assigns a day to a generated cluster according to weather features of the day; for each generated cluster, build a regression model that takes as input weather features of a day and outputs predicted solar power; receive a weather micro-forecast for the solar farm for a future range of days; determine the weather features for a day of the future range of days from the received weather micro-forecast; use the classification model to assign the day to a generated cluster, based on the determined weather features; and use the regression model for the generated cluster to compute a predicted power output for the day.

### BRIEF DESCRIPTION OF THE DRAWINGS

FIG. 1 depicts a functional block diagram of a solar power prediction system, in accordance with an embodiment of the present invention.

FIG. 2 presents various histograms corresponding to different distributions of solar power output for different types of days, in accordance with an embodiment of the present invention.

FIG. 3 is a chart illustrating an example of bias in predicting solar power output, in accordance with an embodiment of the present invention.

FIG. 4 is a block diagram depicting workflow in predicting solar power output, in accordance with an embodiment of the present invention.

FIG. 5 is a flowchart depicting operational steps of a solar power prediction program, in accordance with an embodiment of the present invention.

FIG. 6 is a chart illustrating an example of reduced bias in predicting solar power output, in accordance with an embodiment of the present invention.

FIG. 7 is a schematic diagram illustrating a system for predicting power generation of a solar farm, in accordance with an embodiment of the invention.

FIG. 8 is a flowchart depicting various operational steps performed in predicting power generation of a solar farm, in accordance with an embodiment of the invention.

FIG. 9 is a functional block diagram illustrating a data processing environment, in accordance with an embodiment of the present invention.

### DETAILED DESCRIPTION

Embodiments of the present invention disclose a computer-implemented method, computer program product, and system for predicting solar power output. Descriptive statistics related to a recorded power output profile are used in a clustering algorithm in order to characterize types of days. Historical weather data from micro-forecasts, including statistical quantities computed from irradiance values, is then used to classify days according to these day types identified by clustering. Based on the day classification scheme, a regression model is used to predict power output for future days.

Machine learning is a field of computer science and statistics that involves the construction of algorithms that learn from and make predictions about data. Rather than following explicitly programmed instructions, machine learning methods operate by building a model using example inputs, and using the model to make predictions or decisions about other inputs. Many machine learning tasks are categorized as either supervised or unsupervised learning, depending on the nature of the training examples. Semi-supervised learning has aspects of both supervised and unsupervised learning.

In supervised machine learning, a model is represented by a classification function, which may be inferred, or trained, from a set of labeled training data. The training data consists of training examples, typically pairs of input objects and desired output objects, for example class labels. During training, or learning, parameters of the function are adjusted, usually iteratively, so that inputs are assigned to one or more of the classes to some degree of accuracy, based on a predefined metric. The inferred classification function can then be used to classify new examples. If the output of the classification function is continuous rather than categorical, the machine learning problem is usually referred to as regression. Common classification algorithms include k-nearest neighbors, logistic regression, decision trees, and support vector machines (SVM).

Unsupervised machine learning refers to a class of problems in which one seeks to determine how data is organized. It is distinguished from supervised learning in that the model being generated is given only unlabeled examples. Clustering is an example of unsupervised learning.

Cluster analysis, or clustering, is the task of grouping a set of objects in such a way that objects in the same group, called a cluster, are more similar in some sense to each other than to those in other groups. Clustering is a common technique in statistical data analysis, and is used in fields such as machine learning, pattern recognition, image analysis, and information retrieval. Methods for clustering vary according to the data being analyzed. A method that is popular in data mining is k-means clustering, in which a dataset is partitioned into a predetermined number, k, of clusters. Another method is two-step clustering, with which an optimal number of clusters may be automatically determined.

Semi-supervised learning is a class of supervised learning tasks and techniques that also make use of unlabeled data for training, typically a small amount of labeled data with a large amount of unlabeled data. Semi-supervised learning falls between unsupervised learning, without any labeled training data, and supervised learning, with completely labeled training data. Unlabeled data, when used in conjunction with a small amount of labeled data, may produce a considerable improvement in learning accuracy. For example, in a cluster-and-label approach, data is first clustered (unsupervised learning). For each cluster, supervised learning is used on all labeled instances in the cluster to learn a classifier for the cluster. The classifier is applied to all unlabeled instances in the cluster, which labels them. Finally, supervised learning is used to train a classifier on the entire labeled set.

In an exemplary embodiment of the present invention, semi-supervised learning involves model chaining, in which unlabeled data, characterized by power output, is first clustered. The clusters serve as labels for classifying further data, characterized by weather features. Regression analysis is then applied to the combined model to predict future power output, based on predicted weather features. An advantage to such a classification/regression approach based on semi-supervised learning may be a reduction in bias over current methods of solar power prediction, as discussed in more detail below.

Measurable quantities relevant to solar power prediction may include:
Direct normal irradiance (DNI): DNI is solar radiation that comes in a straight line from the direction of the sun at its current position in the sky.
Direct horizontal irradiance (DHI or DIR): DIR is the irradiation component that reaches a horizontal Earth surface without any atmospheric losses due to scattering or absorption.
Diffuse horizontal irradiance (DIF): DIF is solar radiation that does not arrive on a direct path from the sun, but has been scattered by molecules and particles in the atmosphere and comes equally from all directions. DIF=DNI*cos(theta), where theta is the solar zenith angle.
Global horizontal irradiance (GHI): The total amount of shortwave radiation received from above by a surface horizontal to the ground, GHI=DIR+DIF.
   Historical data including measurements of these quantities at various locations worldwide is available, for example, as part of WRF, and from various online databases. For example, the National Renewable Energy Laboratory maintains the National Solar Radiation Database (NSRDB). The updated 1998-2014 NSRDB includes 30-minute solar and meteorological data for approximately 2 million 0.038-degree latitude by 0.038-degree longitude surface pixels (nominally 4 km²). For PV systems, actual irradiance values are generally measured using pyranometers and pyrheliometers.

Relevant features associated with a day may be of weather type or of power type. Day type features from measured power may include statistics such as sum, mean, standard deviation, median, and first and third quartiles, for example, based on average hourly values. Day type features from a weather forecast may include for each of DIF, DR, DNI, and GHI: sum, mean, standard deviation, median, and first and third quartiles. Weather type features may be extracted from a micro-forecast, as described below.

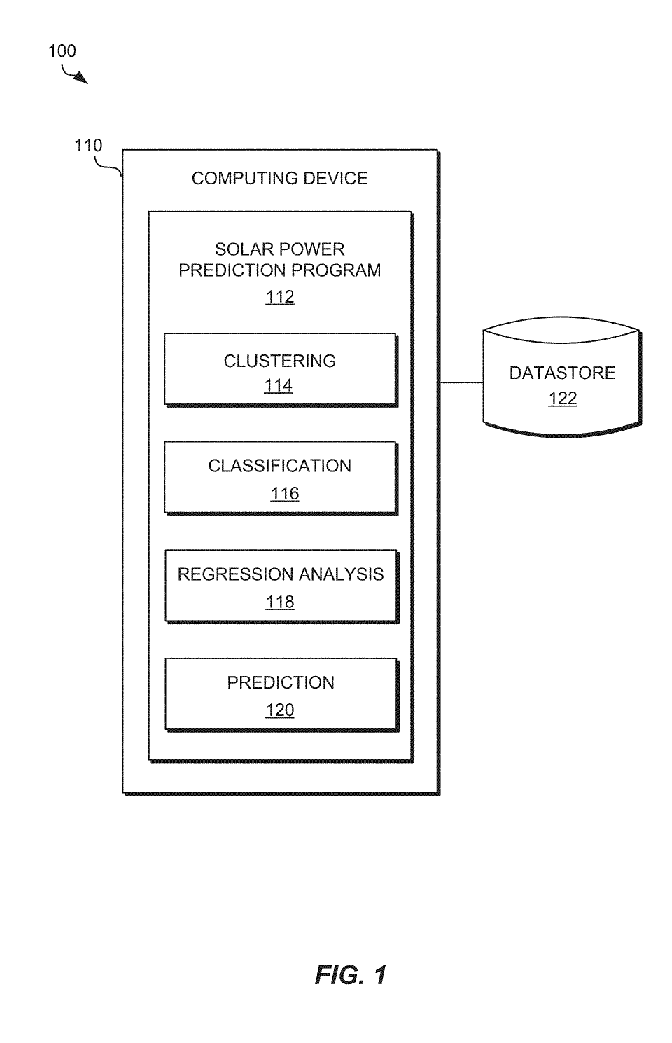

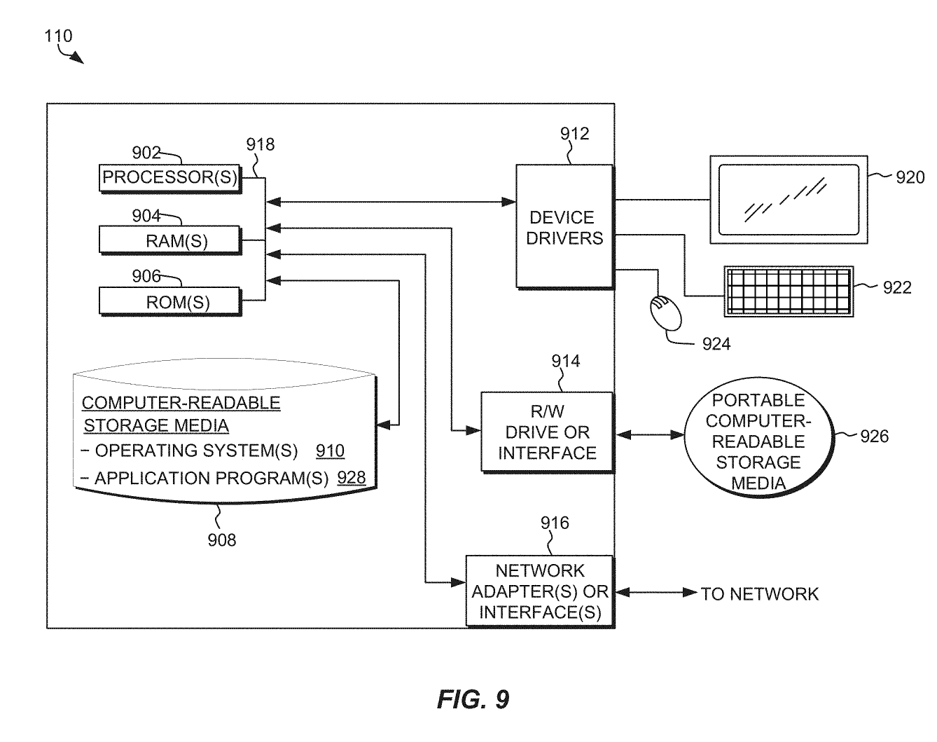

FIG. 1 is a functional block diagram of a solar power prediction system 100, in accordance with an embodiment of the present invention. Solar power prediction system 100 includes computing device 110. Computing device 110 represents the computing environment or platform that hosts solar power prediction program 112. In various embodiments, computing device 110 may be a laptop computer, netbook computer, personal computer (PC), a desktop computer, or any programmable electronic device capable of hosting solar power prediction program 112, in accordance with embodiments of the invention. Computing device 110 may include internal and external hardware components, as depicted and described in further detail below with reference to FIG. 9.

In an exemplary embodiment of the invention, computing device 110 includes solar power prediction program 112 and datastore 122.

Datastore 122 represents a store of data that may undergo clustering and classification, in accordance with an embodiment of the present invention. For example, datastore 122 may include historical data related to weather micro-forecasts and observed power generation for a solar farm. Datastore 122 may also store parameters of a classification model characterizing clusters generated by clustering module 114, as well as parameters of a regression model generated by regression analysis module 118. Datastore 122 may also serve as a repository for micro-forecast data for the solar farm that may be used to predict future solar power output. Datastore 122 may reside, for example, on computer readable storage media 908 (FIG. 9).

A hyperlocal weather forecast, also known as a weather micro-forecast, is a highly localized, detailed, short-term prediction of the weather at a given location, for example in a region including a solar farm. For example, a hyperlocal weather forecast may predict the weather in a square kilometer in 10-minute intervals, or less, 72 hours, or more, ahead of time. Examples of hyperlocal weather forecasting systems are the National Weather Service's High-Resolution Rapid Refresh model and IBM® Deep Thunder. Both are based on the Weather Research and Forecasting (WRF) model, a freely available numerical weather prediction system that was developed by U.S. government agencies and universities.

A weather micro-forecast is generally computed using meteorological observational data that is used as input to a numerical weather model. The meteorological data may be collected by sensors carried, for example, in radiosondes and weather satellites.

Solar power prediction program 112, in an embodiment of the invention, operates generally to build a model that predicts solar power output using a classify and regress approach. Solar power prediction program 112 uses temporal characteristics of the historical power generation profile and a hindcast of forecasting data to categorize days characterized by various weather features according to power features. Solar power prediction program 112 trains a classification model that seeks to minimize classification error, in order to reduce uncertainty due to the weather forecast. A regression model is then trained for each class, in order to reduce bias typically present in a single regression model. Solar power prediction program 112 may include clustering module 114, classification module 116, regression analysis module 118, and prediction module 120.

Features associated with a day may be of weather type or of power type. Weather features for a given day in a set of days for which historical weather data is available may include, for GHI, DNI, DIF, and DIR, the total for the day, mean, standard deviation, first quartile, and third quartile. Power features from measured power at a solar farm for a given day in a set of days may include, for example, for hourly power in kW, the total for the day, mean, standard deviation, median, first quartile, and third quartile.

Clustering module 114 operates generally to create clusters corresponding to types of days with respect to power features relevant to solar power generation at a particular solar farm, in accordance with an exemplary embodiment of the invention. As mentioned, clustering is an example of unsupervised learning. For example, power features for a given day in a set of days for which power output data is available may include the hourly average power generated in kW, the total for the day; and mean, standard deviation, first quartile, and third quartile of the hourly average power values. It will be appreciated that the use of days and hours in this example, while traditional, is non-limiting and other time periods are also contemplated. Clustering module 114 may retrieve the power output data for the solar farm from datastore 122. Clustering module 114 may generate clusters by applying one or more well-known clustering algorithms, for example, k-means, with either a predetermined or automatically determined number of clusters, or a method such as two-step or DBSCAN, for which the determination of the number of clusters is inherent in the method.

In an alternative embodiment, clustering module 114 generates clusters corresponding to types of days with respect to both power features and weather features relevant to solar power generation at a particular solar farm.

Classification module 116 operates generally to create a classification model that categorizes a day characterized by a set of weather features by assigning it to one of the clusters generated by clustering module 114. The clusters generated by clustering module 114 thus serve as labels for days otherwise characterized by their weather features. Classification module 116 may use for this purpose, for example, a standard classification method such as SVM, naïve Bayes, or decision trees.

Regression analysis module 118 operates generally to build a continuous regression model for each cluster generated by clustering module 114. The regression model takes as input weather type features associated with days categorized to the cluster by the classification model created by classification module 116 and produces as output a predicted power. Regression analysis module 118 may use for this purpose, for example, linear regression, a generalized linear model (GLM), neural networks, etc.

Prediction module 120 operates generally to predict future power output using the classification model created by classification module 116 and the regression models built by regression analysis module 118, given a micro-forecast for the corresponding location. Prediction module 120 extracts from the micro-forecast weather type features for a day, uses the classification model created by classification module 116 to assign the day to a cluster, and applies the regression model built by regression analysis module 118 for the cluster to compute a predicted power output.

The forgoing, non-limiting, examples are merely illustrative examples of methods of supervised and unsupervised learning, as well as regression analysis, which may be used in embodiments of the present invention. Others are contemplated.

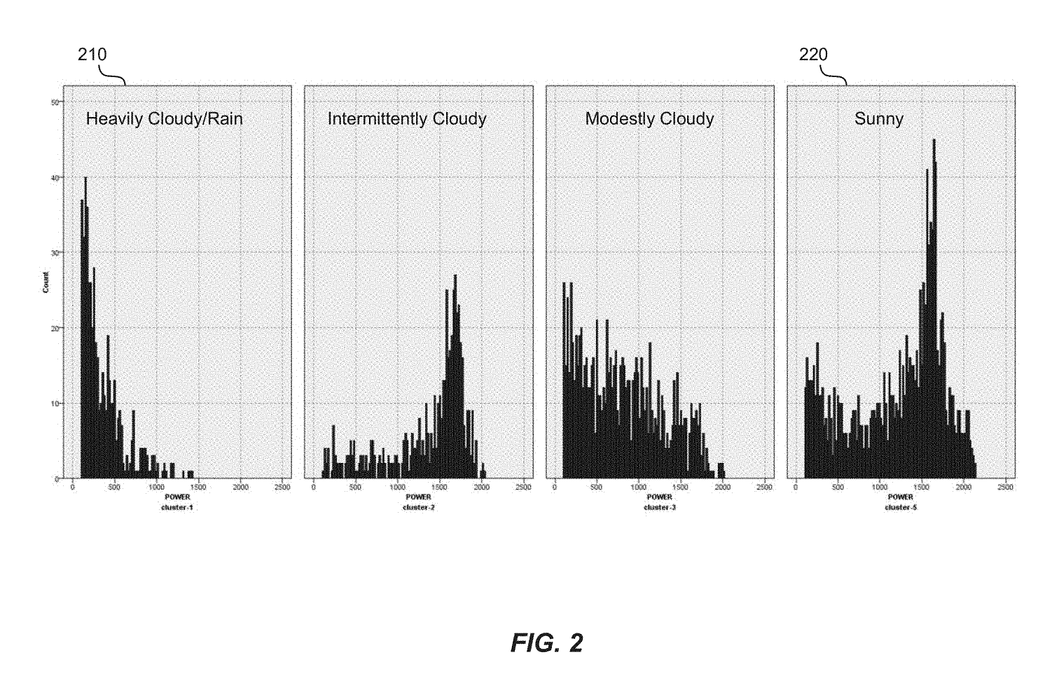

FIG. 2 shows four histograms representing the distribution of power output values for a set of example clusters as might be generated by clustering module 114 (FIG. 1) and classified by classification module 116, according to an embodiment of the invention. The choice of labels ‘Heavily Cloudy/Rain’ (for the first graph 210), ‘Intermittently Cloudy’, ‘Modestly Cloudy’, and ‘Sunny’ (for the last graph 220), are solely for illustration purposes. The individual clusters serve as labels, or categories, for days that belong to them, or which may be assigned to them during power output prediction by prediction module 120. For example, the first graph 210 corresponds to cluster-1 and the last graph 220 corresponds to cluster-5. Each histogram depicts, for a particular type of day during a set observation period, the number of hours for which a solar farm generated power at different average rates. In this example, the bins represent 20 kW intervals. The charts are ordered according to increasing total power output.

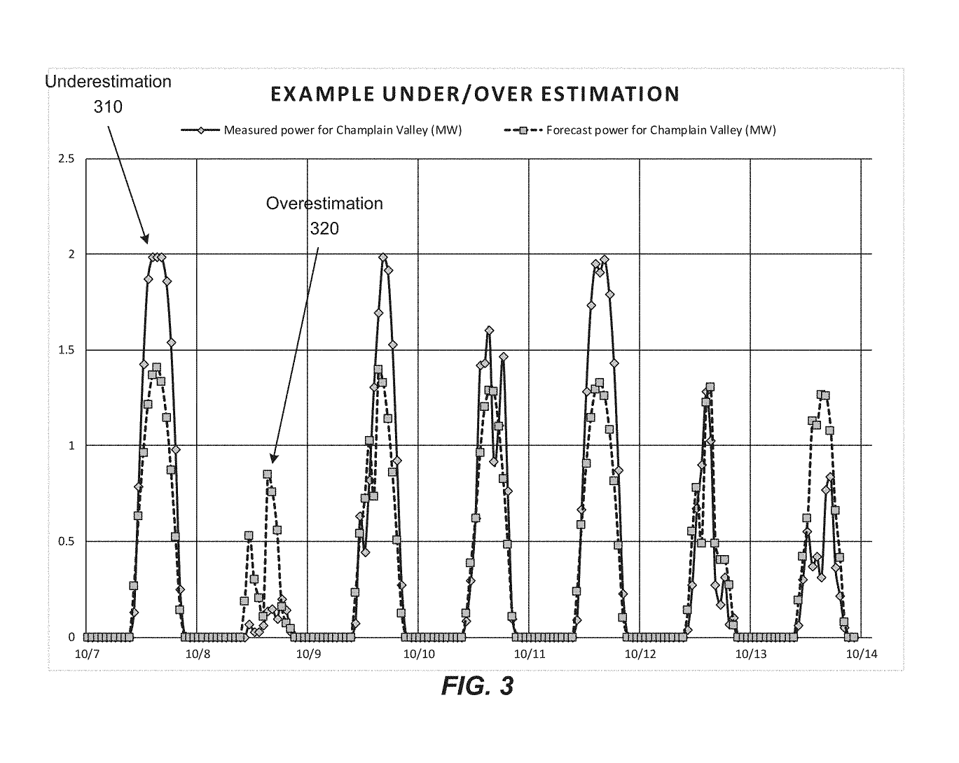

FIG. 3 shows a graph comparing measured power output and predicted power output for a particular solar farm, at 1-hour intervals during a 7-day period, using a standard regression model. FIG. 3 illustrates typical bias in the form of overestimation 320, for example, for days with less irradiance, and underestimation 310, for days with more irradiance.

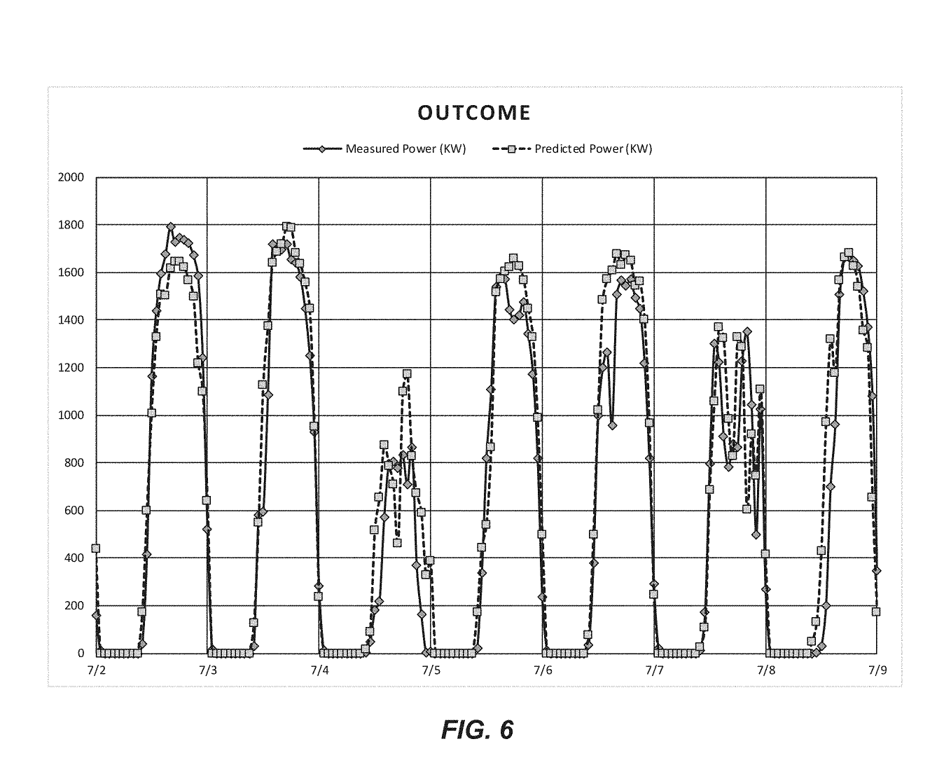

In statistics and machine learning, the bias-variance tradeoff is the problem of simultaneously minimizing two sources of error that may prevent supervised learning algorithms from generalizing beyond their training set. Bias is error from erroneous assumptions in the algorithm. High bias can cause an algorithm to miss the relevant relations between features and target outputs, which is manifested as underfitting. Variance is error from sensitivity to small fluctuations in the training set. High variance can cause overfitting, modeling the random noise in the training data rather than the intended outputs. In traditional regression models, variance may be reduced by increasing the amount of data; however, this may result in increased bias. As mentioned, the present invention addresses the problem of high bias associated with current solar energy prediction models, as illustrated in FIGS. 3 and 6.

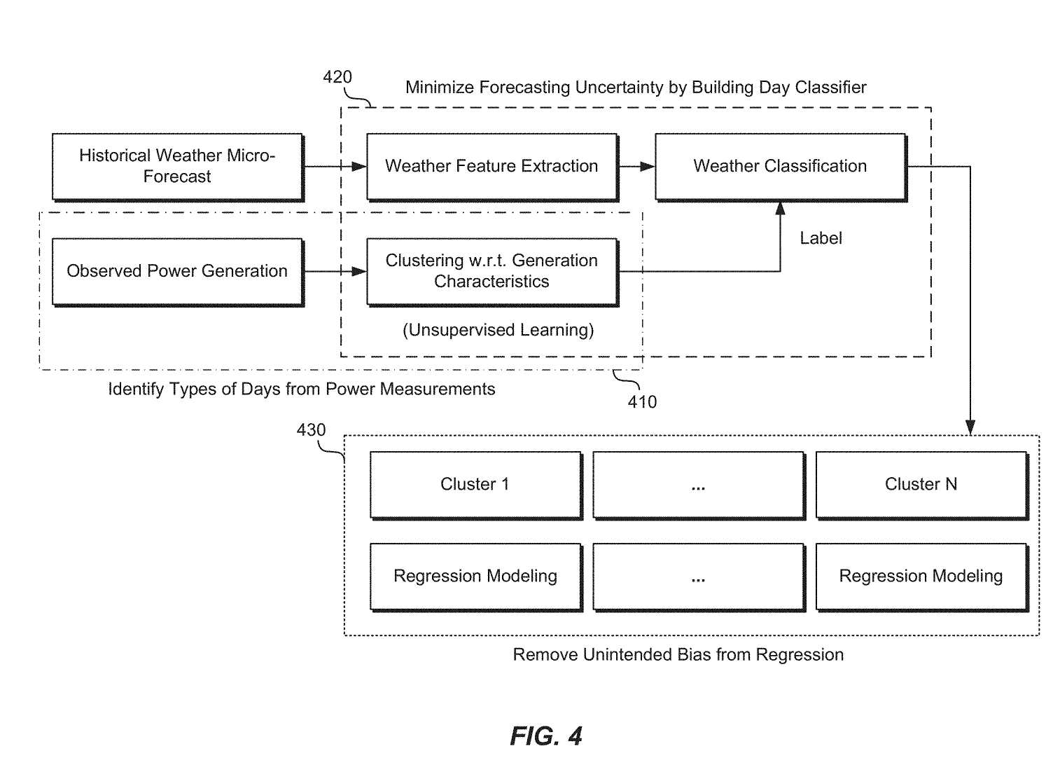

FIG. 4 is a block diagram depicting functional components for building a system to predict solar power output, in accordance with an embodiment of the present invention. The process includes three main components. The first component 410 receives as input observed power generation data for a range of days and performs clustering to identify types, or clusters, to which the input days may be assigned. The second component 420 receives historical weather micro-forecast data for the range of days, extracts weather features relevant to solar power generation, and classifies the days according to the types identified by component 410. The third component 430 builds a continuous regression model for each cluster that predicts solar power output, given weather features of days assigned to the cluster. In this way, bias may be reduced.

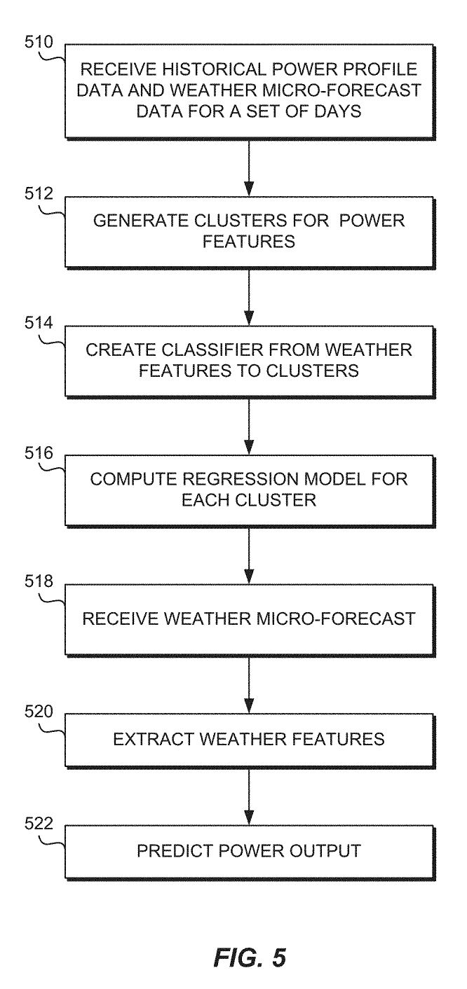

FIG. 5 is a flowchart depicting various operational steps performed by computing device 110 in executing solar power prediction program 112, in accordance with an exemplary embodiment of the invention. Clustering module 114 receives historical power profile data and weather micro-forecast data for a set of days from datastore 122 (step 510). Clustering module 114 generates a set of clusters for the power profile data (step 512). Classification module 116 creates a classification model that categorizes days into clusters according to their weather features (step 514). Regression analysis module 118 builds for each cluster a continuous regression model that maps a set of weather features to a power output (step 516). Prediction module 120 receives a weather micro-forecast (step 518) and extracts the relevant weather features (step 520). Prediction module 120 applies the classification model and the appropriate regression function to predict power output (step 522).

FIG. 6 shows a graph similar to FIG. 3, for a different range of days, comparing measured power output and predicted power output for a particular solar farm, at 1-hour intervals, in accordance with an embodiment of the present invention. In this graph the bias is much less pronounced, compared to FIG. 3.

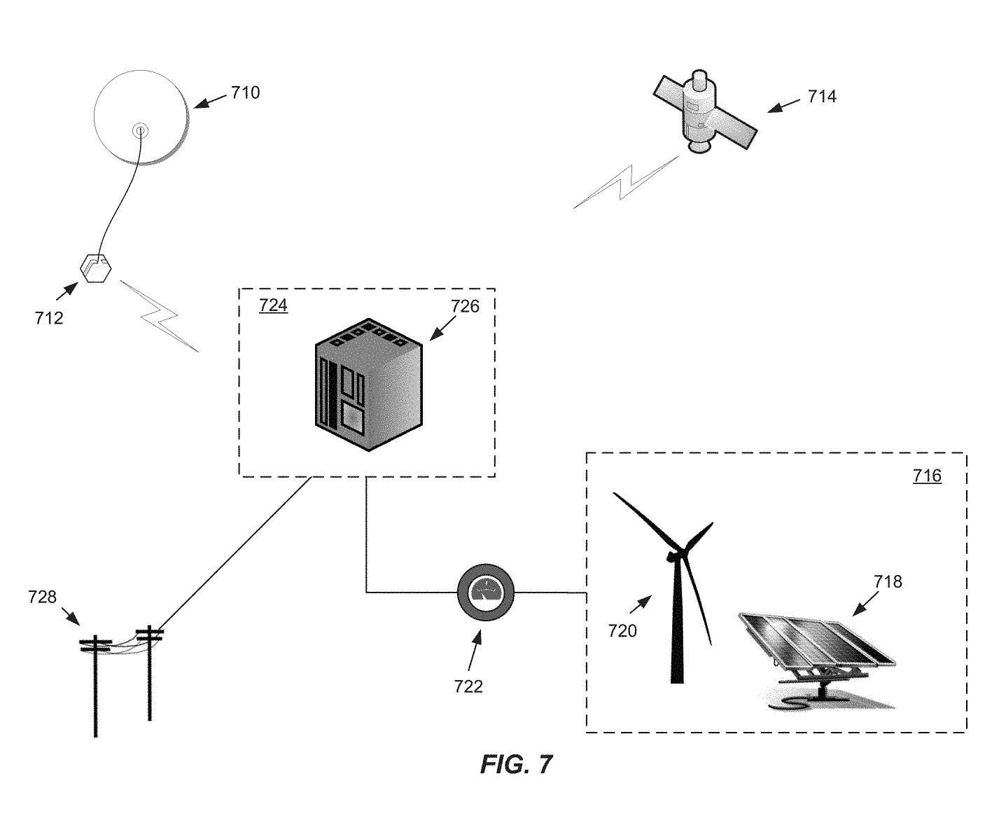

FIG. 7 is a schematic diagram illustrating a system 700 for predicting power generation of a solar farm 716, in accordance with an alternative embodiment of the invention. The system includes sensors for collecting meteorological data in a region of the solar farm, which may include ground sensors such as pyranometers and pyrheliometers (not shown) and atmospheric sensors such as radiosondes 712 attached, for example, to weather balloons 710 and weather satellites 714. The meteorological data may be used along with other data in a numerical weather model such as WRF to generate weather micro-forecasts at the solar farm. The system may also include power meters 722 such as net meters for measuring power output of the solar farm. The system may also include one or more computer processors 726, for example in a grid management system 724, for generating weather micro-forecasts and power output profiles at the solar farm for a set of days in a given time period. The system may also include program instructions to be executed on one or more of the computer processors that implement a method for predicting solar power output, in accordance with an embodiment of the present invention. The system may also include program instructions to be executed on one or more of the computer processors that receive a weather micro-forecast for the solar farm for a future range of days and predict solar power output of the solar farm for days in the future range of days.

In another embodiment of the invention, historical weather micro-forecast data for a hybrid wind-solar farm 716 (FIG. 7) may include additional observational meteorological data pertaining to wind, for example, wind direction and wind speed. Power output measurements may include power generated by a PV system 718 and power generated by wind turbines 720. Power type features may include descriptive statistics for each of these sources separately and/or combined. A method of classification and regression analogous to that for solar power alone may then be applied to predict power output of the hybrid wind-solar farm from a weather micro-forecast for the hybrid wind-solar farm.

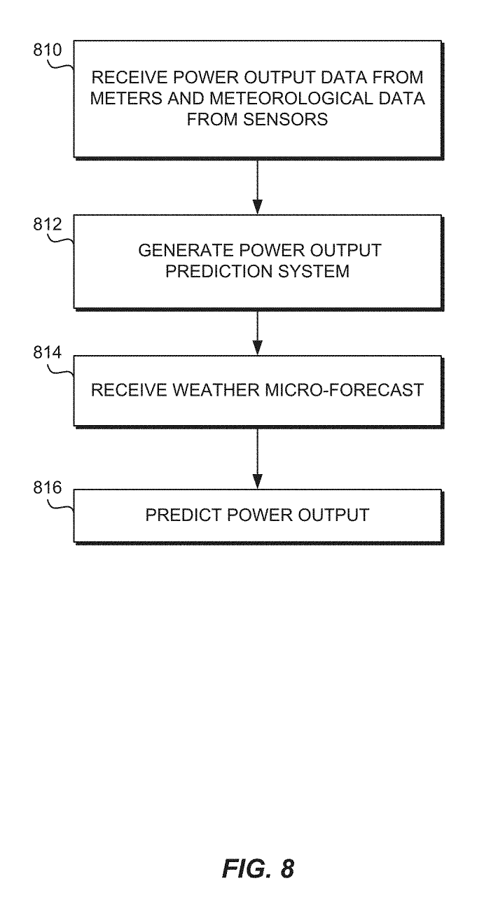

FIG. 8 is a flowchart depicting various operational steps performed by system 700 (FIG. 7) in predicting power generation of a solar farm 716, in accordance with an embodiment of the invention. Power output data from power meters 722 and meteorological data from sensors such as radiosonde 712 and weather satellite 714 is received (step 810). A power output prediction system, as described above, is generated (step 812). A weather micro-forecast for the solar farm for a future time period is received (step 814). Power output for the future time period is predicted, based on the power output prediction system (step 816).

FIG. 9 depicts a block diagram of components of a computing device 110, in accordance with an embodiment of the present invention. It should be appreciated that FIG. 9 provides only an illustration of one implementation and does not imply any limitations with regard to the environments in which different embodiments may be implemented. Many modifications to the depicted environment may be made.

Computing device 110 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 928, for example, solar power prediction program 112, are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing device 110 may also include a R/W drive or interface 914 to read from and write to one or more portable computer readable storage media 926. Application programs 928 on computing device 110 may be stored on one or more of the portable computer readable storage media 926, read via the respective R/W drive or interface 914 and loaded into the respective computer readable storage media 908.

Computing device 110 may also include a network adapter or interface 916, such as a TCP/IP adapter card or wireless communication adapter (such as a 4G wireless communication adapter using OFDMA technology). Application programs 928 on computing device 110 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

Computing device 110 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user s. The device drivers 912, R/W drive or interface 914 and network adapter or interface 916 may comprise hardware and software (stored on computer readable storage media 908 and/or ROM 906).

The present invention may be a system, a method, and/or a computer program product. The computer program product may include a non-transitory computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the C programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The foregoing description of various embodiments of the present invention has been presented for purposes of illustration and description. It is not intended to be exhaustive nor to limit the invention to the precise form disclosed. Many modifications and variations are possible. Such modification and variations that may be apparent to a person skilled in the art of the invention are intended to be included within the scope of the invention as defined by the accompanying claims.

What is claimed is:

1. A computer-implemented method for predicting photovoltaic solar power generation, the method comprising:
receiving, by one or more processors, historical power profile data and historical weather micro-forecast data at a given location for a set of days;
generating, by one or more processors, clusters from the set of days, the clusters corresponding to types of days, according to power output features of days of the set of days;
creating, by one or more processors, a classification model that assigns a day to a generated cluster according to weather features of the day; and
for a generated cluster, building, by one or more processors, a regression model that takes as input weather features of a day and outputs predicted solar power.

2. The method of claim 1, wherein historical weather micro-forecast data comprises measurements at specified time intervals of one or more of:
direct normal irradiance, direct horizontal irradiance, diffuse horizontal irradiance, global horizontal irradiance, and solar zenith angle.

3. The method of claim 2, wherein the specified time intervals are hours.

4. The method of claim 1, wherein historical power output data comprises measurements of generated power output at specified time intervals.

5. The method of claim 4, wherein the specified time intervals are hours.

6. The method of claim 1, wherein generating clusters comprises using, by one or more processors, an unsupervised machine learning method.

7. The method of claim 6, wherein the unsupervised machine learning method is one of: k-means, two-step, or DBSCAN.

8. The method of claim 1, wherein the power output features comprise statistics based on averages of power measurements over specified time intervals.

9. The method of claim 8, wherein the statistics comprise one or more of:
sum, mean, standard deviation, median, first quartile, and third quartile.

10. The method of claim 1, wherein creating a classification model comprises using, by one or more processors, a supervised machine learning method.

11. The method of claim 10, wherein the supervised machine learning method is one of: SVM, naïve Bayes, or decision trees.

12. The method of claim 1, wherein the weather features comprise statistics based on averages over specified time intervals of one or more of:
direct normal irradiance, direct horizontal irradiance, diffuse horizontal irradiance, and global horizontal irradiance.

13. The method of claim 12, wherein the statistics comprise one or more of:
sum, mean, standard deviation, median, first quartile, and third quartile.

14. The method of claim 1, wherein the regression model comprises one or more of:
linear regression, a general linear model (GLM), and a neural network.

15. The method of claim 1, further comprising:
receiving, by one or more processors, a weather micro-forecast for the given location for a range of days;
determining, by one or more processors, the weather features for a day of the range of days from the weather micro-forecast;
using, by one or more processors, the classification model to assign the day to a generated cluster, based on the determined weather features; and
using, by one or more processors, the regression model for the generated cluster to compute a predicted power output for the day.

16. A system for predicting photovoltaic solar power generation of a solar farm, the system comprising:
a sensor for collecting meteorological data in a region of a solar farm for use in a numerical weather model;
a meter for measuring photovoltaic power output of the solar farm;
one or more computer processors, one or more non-transitory computer-readable storage media, and program instructions stored on one or more of the computer-readable storage media for execution by at least one of the one or more processors, the program instructions comprising:
program instructions to receive meteorological data collected from the sensor for use in a numerical weather model;
program instructions to receive photovoltaic power output measurements measured by the meter corresponding to a predefined time period;
program instructions to generate a weather micro-forecast for the time period in the region of the solar farm, based on the meteorological data and the numerical weather model;
program instructions to produce a profile of photovoltaic power generated during the time period at the solar farm, based on the photovoltaic power output measurements;
program instructions to receive the photovoltaic power profile and the weather micro- forecast at the solar farm for a set of days of the time period;
program instructions to generate clusters from the set of days corresponding to types of days, according to power output features of days of the set of days;
program instructions to create a classification model that assigns a day to a generated cluster according to weather features of the day;
program instructions, for a generated cluster, to build a regression model that takes as input weather features of a day and outputs predicted solar power;
program instructions to receive a weather micro-forecast for the solar farm for a future range of days;
program instructions to determine the weather features for a day of the future range of days from the received weather micro-forecast;
program instructions to use the classification model to assign the day to a generated cluster, based on the determined weather features; and
program instructions to use the regression model for the generated cluster to compute a predicted power output for the day.

17. The system of claim 16, wherein historical weather micro-forecast data comprises hourly measurements of one or more of:
direct normal irradiance, direct horizontal irradiance, diffuse horizontal irradiance, global horizontal irradiance, and solar zenith angle.

18. The system of claim 16, wherein historical power output data comprises hourly measurements of generated power output.

19. The system of claim 16, wherein program instructions to generate clusters comprises program instructions to use an unsupervised machine learning method.

20. The system of claim 16, wherein the power output features comprise statistics based on average hourly values of power measurements.

21. The system of claim 16, wherein program instructions to create a classification model comprise program instructions to use a supervised machine learning method.

22. The system of claim 16, wherein the weather features comprise statistics based on hourly averages of one or more of:
direct normal irradiance, direct horizontal irradiance, diffuse horizontal irradiance, and global horizontal irradiance.

23. A computer program product for predicting photovoltaic solar power generation, the computer program product comprising:
one or more non-transitory computer-readable storage media and program instructions stored on the one or more computer-readable storage media, the program instructions comprising:
program instructions to receive historical power profile data and historical weather micro-forecast data at a given location for a set of days;
program instructions to generate clusters from the set of days corresponding to types of days, according to power output features of days of the set of days;
program instructions to create a classification model that assigns a day to a generated cluster according to weather features of the day; and
program instructions, for a generated cluster, to build a regression model that takes as input weather features of a day and outputs predicted solar power.

24. The computer program product of claim 23, further comprising:
program instructions to receive a weather micro-forecast for the given location for a range of days;
program instructions to determine the weather features for a day of the range of days from the weather micro-forecast;
program instructions to use the classification model to assign the day to a generated cluster, based on the determined weather features; and
program instructions to use the regression model for the generated cluster to compute a predicted power output for the day.
